(19) United States
(12) Patent Application Publication
(10) Pub. No.: US 2025/0258096 A1
(43) Pub. Date: Aug. 14, 2025

(54) PHASE MASKING FOR POLARIZATION AND OPTICAL SIGNAL CONTROL IN OPTICAL INSPECTION SYSTEMS

(71) Applicant: Applied Materials, Inc., Santa Clara, CA (US)

(72) Inventors: Elad Eizner, Nes Ziona (IL); Hadar Greener, Rehovot (IL); Woosung Ha, Seongnam-si (KR); Tal Kuzniz, Kfar Saba (IL)

(21) Appl. No.: 18/438,222

(22) Filed: Feb. 9, 2024

(51) Int. Cl. G01N 21/47; G01N 21/17; G01N 21/95; G01N 35/00

(52) U.S. Cl. CPC G01N 21/4738; G01N 21/1717; G01N 21/9501; G01N 35/00613; G01N 2021/1721

(57) ABSTRACT

Implementations disclosed describe, among other things, a sample inspection system that includes an illumination subsystem to generate a light incident on a sample. The sample inspection system includes a collection subsystem having optical elements to collect a light generated upon interaction of the incident light with the sample. The sample inspection system further includes a light detection subsystem configured to detect the collected light and generate one or more signals representative of characteristics of the sample. The sample inspection system deploys a phase mask that interacts with the incident light and/or the collected light and includes a first region and a second region imparting different phases to the light incident on the phase mask.

### TECHNICAL FIELD

This instant specification generally relates to quality control of materials manufactured in substrate processing systems. More specifically, the instant specification relates to optical inspection methods and devices for use in quality control of substrates, wafers, masks, and other products during various stages of manufacturing.

### BACKGROUND

Manufacturing of modern materials often involves various deposition techniques, e.g., chemical vapor deposition, physical vapor deposition techniques, atomic layer deposition techniques, etching techniques, polishing techniques, photo-masking techniques, and/or various other manufacturing techniques. Materials and devices manufactured in this manner may include monocrystals, semiconductor films, fine coatings, patterns, arrays of transistors, dies, chips, and numerous other structures used in practical applications, such as electronic device manufacturing. Many of these applications rely on the purity of the materials and/or accuracy of structures prepared in manufacturing systems. Various detection and sensing systems are used to monitor adherence of processing operations to manufacturing specification, maintain optimal chemical composition and physical conditions of processing environments, and so on. Quality of intermediate and final products is monitored with inspection systems, including optical inspections. Optical inspections can include reflectometry techniques, spectrometry techniques, ellipsometry techniques, etc. Optical inspections can be performed using specularly reflected light, diffusely reflected (scattered) light, transmitted light, or various combinations thereof.

### BRIEF DESCRIPTION OF THE DRAWINGS

FIG. 1 illustrates an example optical inspection system capable of deploying phase masks for optical inspections performed in the context of manufacturing operations, in accordance with at least one embodiment.

FIG. 2 illustrates an example optical inspection tool capable of deploying phase masks for improving optical inspection signals, in accordance with at least one embodiment.

FIGS. 3A-3C illustrate deployment of an example two-segment phase mask deployed as part of an illumination subsystem of the optical inspection tool of FIG. 2, in accordance with at least one embodiment.

FIGS. 4A-4G illustrate deployment of an example two-segment phase mask of FIG. 3C to amplify out-of-plane dipole and quadrupole resonances in the detection channel of the optical inspection tool of FIG. 2, in accordance with at least one embodiment.

FIGS. 5A-5D illustrate deployment of an example four-segment phase mask of FIG. 3C to amplify multipole resonances by the detection channel of the optical inspection tool of FIG. 2, in accordance with at least one embodiment.

FIGS. 6A-6D illustrate example use of birefringent materials for construction of phase masks, in accordance with at least one embodiment.

FIGS. 7A-7D illustrate another use of an example two-segment phase mask to amplify detection of magnetic dipole resonances, in accordance with at least one embodiment.

FIGS. 8A-8E illustrate an example embodiment of a phase mask that deploys an acousto-optic modulator, in accordance with some aspects of the present disclosure.

FIGS. 9A-9B are flow diagrams of example methods of deploying phase masks for improving optical inspection signals, in accordance with at least one embodiment.

### SUMMARY

Some of the embodiments described herein are related to a sample inspection system that includes an illumination subsystem to generate a light incident on a sample. The sample inspection system further includes a collection subsystem having one or more optical elements to collect a light generated upon interaction of the incident light with the sample. The sample inspection system further includes a light detection subsystem configured to detect the collected light and generate one or more signals representative of one or more characteristics of the sample. The sample inspection system includes a phase mask positioned to interact with at least one of the incident light or the collected light. The phase mask may include at least a first region to engage a first portion of a light interacting with the phase mask, and a second region to (i) engage a second portion of the light interacting with the phase mask and (ii) phase-shift the second portion relative to the first portion.

Another embodiment described is related to a method to perform an inspection of a sample. The method includes generating a source light and directing the source light to a phase mask. The phase mask includes a first region to interact with a first portion of the source light, and a second region to (i) interact with a second portion of the source light and (ii) phase-shift the second portion of the source light relative to the first portion of the source light. The method further includes illuminating the sample using the source light, collecting a light generated upon interaction of the source light with the sample, directing the collected light to a light detection sensor to generate one or more of signals, and determining, using the one or more signals, one or more characteristics of the sample.

Yet another embodiment described is related to a method to perform an inspection of a sample. The method includes generating a source light, illuminating the sample using the source light, and collecting a light generated upon interaction of the source light with the sample. The method further includes directing at least a part of the collected light to a phase mask. The phase mask includes a first region to interact with a first portion of the collected light, and a second region to (i) interact with a second portion of the collected light and (ii) phase-shift the second portion of the collected light relative to the first portion of the collected light. The method further includes directing the collected light to a light detection sensor to generate one or more signals, and determining, using the one or more signals, one or more characteristics of the sample.

### DETAILED DESCRIPTION

Semiconductor device manufacturing often involves tens and even hundreds of complex operations to implement raw wafer (substrate) preparation, polishing, material deposition, etching, and the like. Since even a small number of impurities or other defects introduced into processing environments during such operations can render the manufacturing products (masks, wafers, chips, etc.) unusable for their intended purposes, various manufacturing operations are often interspersed with quality control inspections to verify adherence of intermediate and final products to specifications of the technological processes being performed. Inspections can determine the degree of cleanliness of products, also referred to as samples herein, presence of defects in the samples, dimensions of the samples, physical and chemical compositions of the samples, surface morphology of the samples, and/or the like.

Optical (including ultraviolet) inspection systems are capable of efficiently detecting impurities, crystal lattice/morphology defects, surface roughness, thickness non-uniformities, and/or other product imperfections. Optical inspection systems can implement bright-field inspection techniques (which use specular reflection of a probe light from samples), dark-field inspection techniques (which use non-specular scattering of the probe light from samples), and/or a combination thereof. A sample (can be temporarily removed from a processing line and scanned, location by location, using an optical inspection system that includes an illumination subsystem, a light collection subsystem, various additional optical elements, polarizers, field stops, a light detection subsystem, a data processing subsystem, and/or the like. A sample should be understood as any patterned or unpatterned wafer. An unpatterned wafer can include a bare wafer, a wafer covered with any number of films, layers, a polished, grinded, annealed wafer, and/or any wafer that has undergone one or more processing operations that maintain or establish a wafer uniformity. A patterned wafer can include any wafer with deposited, grown, etched, cut, or otherwise formed spatially non-uniform features, which can include one or more devices, such as logic/memory transistors, interconnect circuitry, and/or combination of such devices grouped into, dies, chips, blocks, and/or the like.

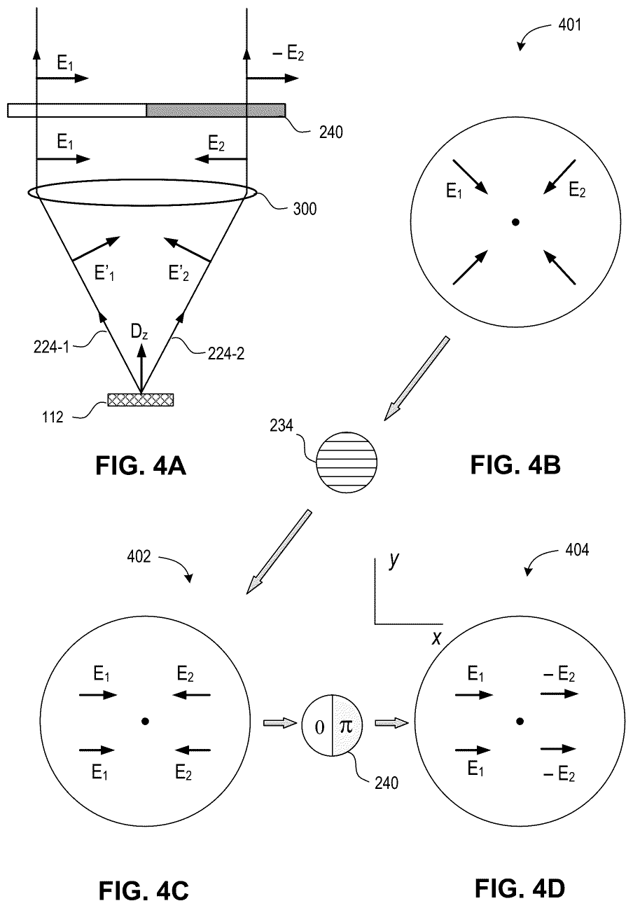

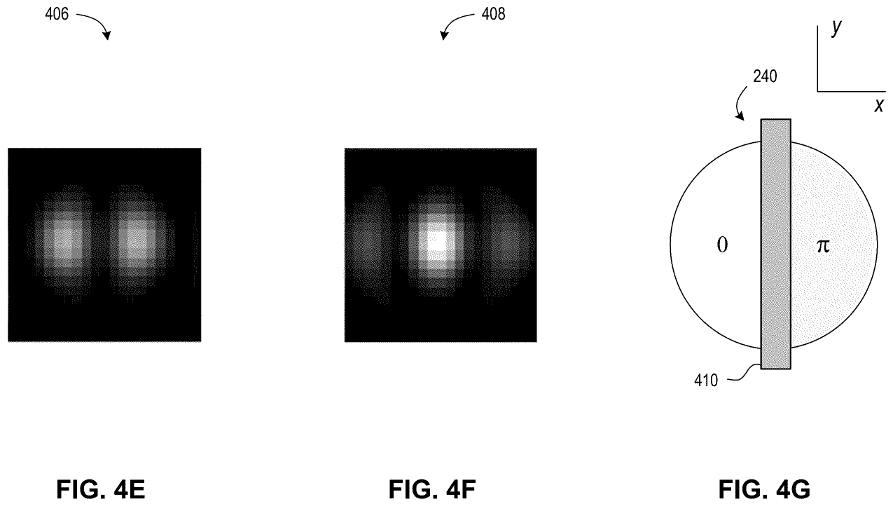

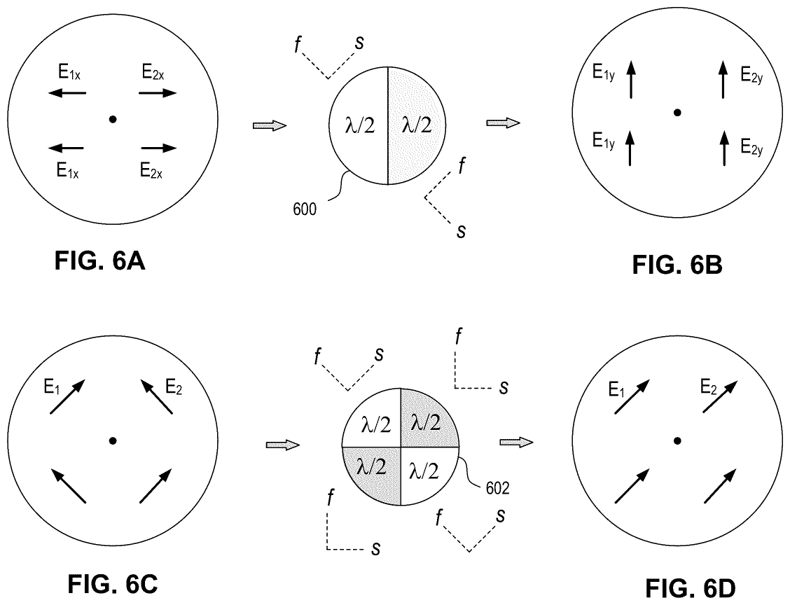

Various imperfections and defects of samples can often have a resonant character where a certain mode, e.g., a dipole mode, a quadrupole mode, or a higher multipole mode (or some combination thereof) is responsible for a large portion of scattered (or reflected) radiation from the locale of the imperfection/defect. Such resonant radiation typically has a distinct angular pattern. For example, an electric dipole oriented perpendicularly to the surface of a sample (along the z-axis) produces radiation—at a pupil plane of a collection system—with the radial pattern of the in-plane electric field (e.g., as illustrated in FIGS. 4A-4B) while multipole in-plane combinations can result in other radiation symmetries (as illustrated in FIGS. 6A-6B). Collecting radiation of such patterns using conventional uniform polarizers can result in optical signals with a low signal-to-noise (SNR) ratio, which reduces the likelihood of successful defect/imperfection detection.

Aspects and embodiments of the present disclosure address these and other challenges of the existing technology by providing for techniques and systems that deploy phase masks imparting spatially inhomogeneous phase changes to the transmitted light. In one example embodiment, a phase mask includes a first region and a second region imparting different phases —e.g., by π (half the wavelength of light)—to the light incident on the mask. Correspondingly, when a first portion of a beam (e.g., reflected or scattered beam) is transmitted through (or reflected from) the first region and a second portion of the beam is transmitted through (or reflected from) the second region, the relative direction of the electric fields in the two portions is reversed. For example, if the first portion and the second portion initially had antiparallel electric fields, the respective portions of the transmitted (or reflected) beam will have parallel electric fields. Such phase masks—suitably oriented within a pupil plane—can be used to increase optical signal SNR by replacing destructive interference of the reflected/scattered radiation incident on photodetectors with constructive interference.

In another example embodiment, a phase mask can include more than two distinct regions, e.g., a first set of n regions that impart a π phase change relative to a second set of regions, which are interspaced with the regions of the first set. Such phase masks can be used to improve SNR of the reflected/scattered optical signals in the instances of electric fields in such signals experiencing 2n sign changes within the pupil plane. Polarization light may be manipulated, according to the disclosed techniques, in a coherent pupil plane of the illumination subsystem of the optical system, of the collection subsystem of the optical system, or both. Phase masks disclosed herein can be passive masks or active masks. A passive (static) phase mask can include any optical elements or a combination of optical elements having properties that are fixed throughout a duration of an optical inspection, e.g., one more films deposited on a glass. An active (dynamic) phase mask can include any optical elements or a combination of optical elements in which at least one characteristics can be controlled during the optical inspection (or in preparation to optical inspection), e.g., acousto-optic modulator whose properties (such as refractive index) can be controlled by controlling an amplitude and phase of a sound wave passing therethrough, an electro-optic modulator whose properties can be controlled by adjusting electric field (voltage) applied thereto, and/or the like. The advantages of the disclosed systems and techniques include the improved efficiency and accuracy of defect and imperfection detection of inspection of various products of semiconductor manufacturing.

The disclosed embodiments pertain to optical inspections performed in the context of a variety of manufacturing techniques, such as bare wafer manufacturing, chemical mechanical polishing (CMP), physical vapor deposition (PVD), chemical vapor deposition (CVD), plasma-enhanced PVD and/or CVD, atomic layer CVD, combustion CVD, catalytic CVD, evaporation deposition, molecular-beam epitaxy techniques, wafer patterning, photo-mask application, etching, and/or other techniques. The disclosed embodiments can also be advantageously used to improve manufacturing techniques that use vacuum deposition chambers (e.g., ultrahigh vacuum CVD or PVD, low-pressure CVD, etc.) and/or atmospheric pressure deposition chambers.

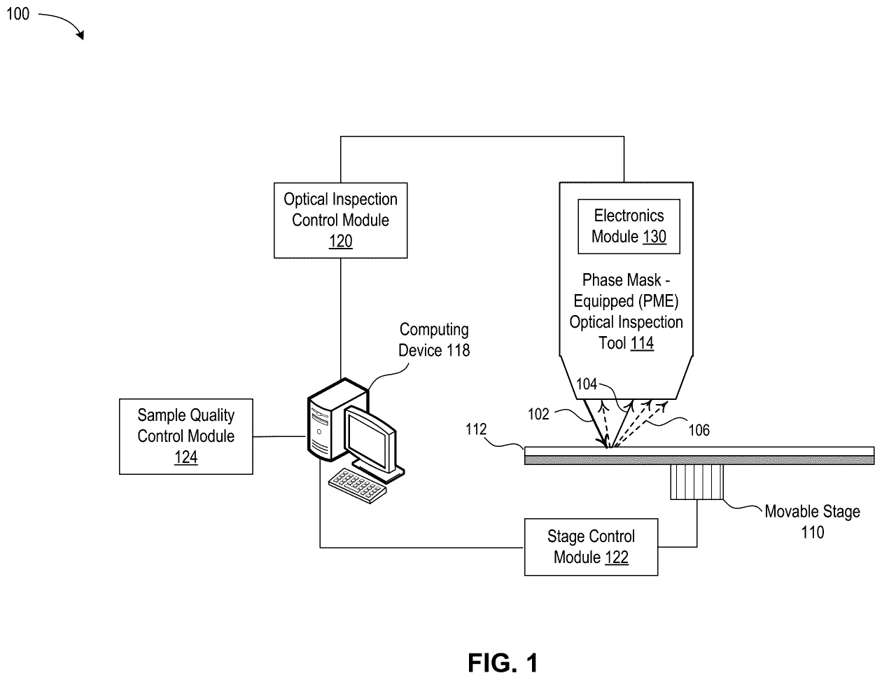

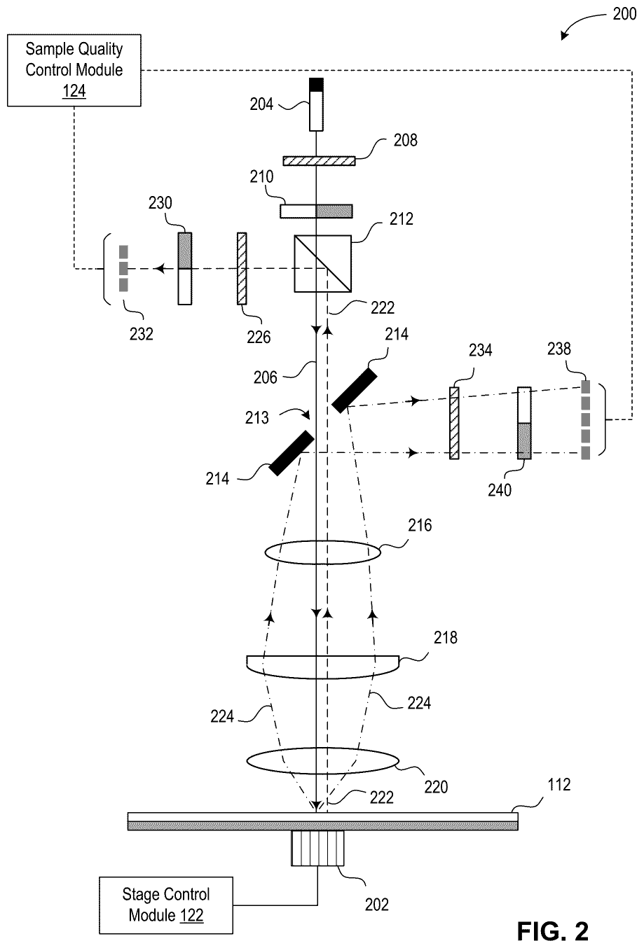

FIG. 1 illustrates an example optical inspection system 100 capable of deploying phase masks for optical inspections performed in the context of manufacturing operations, in accordance with at least one embodiment. In some embodiments, optical inspection system 100 can be used to perform inline inspection where a product is being transferred between processing chambers, between a processing chamber and a transfer chamber, between a transfer chamber and a load lock chamber, between a load-lock chamber and a product carrier, and/or the like. In some embodiments, optical inspection system 100 can be used as a free-standing inspection system. In some embodiments, optical inspection is performed on a sample 112 (e.g., wafer, a mask, a film, a patterned product, or any combination thereof) carried by movable stage 110 (e.g., a robot blade) that supports and moves sample 112. In some embodiments, a phase mask-equipped (PME) optical inspection tool 114 can be used to facilitate optical inspections of sample 112, as described in more detail in conjunction with FIGS. 2-9.

PME optical inspection tool 114 scans sample 112 with one or more beams of light 102 and collects light reflected from sample 112, e.g., specularly reflected light 104 (as part of bright-field inspection) and/or non-specularly (diffusely) scattered light 106 (as part of dark-field inspection). Although FIG. 1 depicts oblique incidence of beam 102, in other embodiments, beam 102 can be incident normally on the surface of sample 112. PME optical inspection tool 114 can be configured to use visible light, UV light, and/or other electromagnetic radiation to inspect sample 112.

An electronics module 130 can control operations of PME optical inspection tool 114 and can further control at least some processing of optical inspection data collected by PME optical inspection tool 114. Electronics module 130 can include a microcontroller and a memory device (e.g., buffer) coupled to the microcontroller. The memory device can be used to store instructions that control operations of PME optical inspection tool 114 and optical inspection data before transmitting the optical inspection data to a computing device 118. Computing device 118 can include optical inspection control module 120 that selects (e.g., in response to instructions stored on computing device 118 or received from a human operator of optical inspection system 100) modes of inspection, resolution of inspection, wavelengths used by PME optical inspection tool 114, inspection frequency (e.g., scanning frequency or pulsed light source repetition rate), wavelength of inspection, zoom of objectives, types and spatial orientations of phase masks, and the like. Computing device 118 can further include a stage control module 122 that controls speed and timing of rotational and/or translational motion of sample 112 relative to PME optical inspection tool 114. Computing device 118 can operate a sample quality control module 124 that processes optical inspection data collected by PME optical inspection tool 114 and determines physical/chemical composition of sample 112, e.g., quality and quantity of impurities, surface imperfections, pattern defects, variations in thickness, and the like. Sample quality control module 124 can compare the obtained morphological, physical, chemical, etc., properties of sample 112 with specifications of the manufacturing process being performed and determine adherence of sample 112 to those specifications. Sample quality control module 124 can then determine whether the manufacturing process is to be continued or stopped, whether sample 112 is to be removed from the processing line, returned to the processing line for further processing (e.g., additional polishing, deposition, cleaning, etc.), whether a warning or an alarm signal is to be output to the operator, or can take any number of other programmed actions.

FIG. 2 illustrates an example optical inspection tool 200 capable of deploying phase masks for improving optical inspection signals, in accordance with at least one embodiment. Optical inspection tool 200 can be used to inspect sample 112 supported by a movable stage 202 (e.g., robot blade or some other similar movable stage). Optical inspection tool 200 can include an illumination subsystem configured to generate light that is normally and/or obliquely incident on sample 112. In some embodiments, the illumination subsystem is configured to illuminate sample 112 at any range of angles, e.g., through any portion of a numerical aperture (NA) or a full NA of the illumination subsystem. As depicted in FIG. 2, the illumination subsystem can include a light source 204 configured to generate an incident light 206 that is used for normal (as illustrated in FIG. 2) or oblique illumination of sample 112. Although in FIG. 2, a single light source 204 is used to illuminate sample 112 for both bright-field inspection and dark-field inspection, in other embodiments, multiple light sources can be used, e.g., separate light sources for bright-field inspection and or dark-field inspection. In some embodiments, incident light 206 can be a flood beam. In some embodiments, incident light 206 can be a spot beam focused on a particular spot of sample 112. The spot can be repositioned relative to sample 112 using movable stage 202. In some embodiments, the size of the illuminated spot can be smaller than 1 mm. Intensity of illumination of the spot can be controlled by controlling the size of the spot and/or by controlling the intensity of light produced by light source 204 (and/or other light sources, if deployed).

In some embodiments, light source 204 can include a broadband lamp, a narrow-band laser, a light-emitting diode, a semiconductor laser, a gas laser, a pulsed laser, a continuous wave laser, or some other type of a light source.

Incident light 206 can pass through one or more polarizers 208, which should be understood as any optical element/device or a combination of optical elements/devices configured to control polarization of the light incident on sample 112. Polarizers 208 can cause incident light 206 to become linearly polarized along any direction (e.g., x-direction, y-direction, and/or some other direction), s-polarized (perpendicular to the plane of incidence on sample 112), p-polarized (parallel to the plane of incidence on sample 112), circularly polarized (e.g., right-handed or left-handed circularly polarized), elliptically polarized, partially polarized, and/or the like. Polarizer 208 (and/or other polarizers that can be deployed by optical inspection tool 200) can be absorptive polarizers, reflective polarizers, beam-splitting polarizers, birefringent polarizers (e.g., quarter-wave plates, half-wave plates), thin-film polarizers, nanoparticle-based polarizers, S-waveplate converters (which can convert linear polarization to radial or azimuthal polarization and can convert circular polarization to an optical vortex), and/or any other suitable polarizers. In some embodiments, polarizer 208 can include a segmented linear polarizer that includes two or more al linear polarizer segments with axes of polarization having a different orientation.

Incident light 206 can also pass through a phase mask 210, a beam splitter 212, and an aperture 213 in a splitting mirror 214 that separates reflected bright-field light from scattered dark-field light. Incident light 206 can be relayed through a relay optics 216 towards telescope optics 218 and objective 220, each of which can include one or more optical elements (e.g., lenses, mirrors, etc.). At least some elements of telescope optics 218 can be movable relative to objective 220 (and/or relative to other elements of telescope optics 218) to support multiple spot sizes and/or zooms (magnifications).

Incident light 206 striking sample 112 can generate a specularly reflected light 222 (bright-field light) and a scattered light 224 (dark-field light). Scattered light 224 can propagate (with an angle-dependent intensity) along a continuum of directions with two such directions indicated schematically in FIG. 2 with the dot-dashed lines. A collection subsystem of optical inspection tool 200 can collect light reflected and/or scattered from sample 112. In some embodiments, the collection subsystem can share one or more optical elements with the illumination subsystem, e.g., objective 220, telescope optics 218, relay optics 216, etc., in the example embodiment of FIG. 2. A number and types of lenses (mirrors, diffraction elements) in objective 220 and/or telescope optics 218 can be selected using any known techniques, e.g., to reduce light aberration, including but not limited to chromatic aberration.

The bright-field reflection channel can collect reflected light 222 (indicated with the dashed line) using objective 220 and telescope optics 218 and relay the collected reflected light 222, via relay optics 216, to beam splitter 212. Beam splitter 212 can direct reflected light 222 towards polarizer 226, phase mask 230, and one or more optical elements (e.g., focusing optics, relay optics, etc., not shown in FIG. 2), which direct reflected light 222 to bright-field detectors 232. In some embodiments, polarizer 226 can transmit polarization that is the same as polarization of incident light 206 produced by polarizer 208. For example, polarizer 208 can impart s-polarization to incident light 206 and polarizer 226 can likewise transmit s-polarization towards bright-field detectors 232. In some embodiments, polarizer 226 can transmit polarization that is different from polarization produced by polarizer 208. For example, polarizer 208 can impart s-polarization to incident light 206 and polarizer 226 can transmit p-polarized (or vice versa) reflected light 222 towards bright-field detectors 232. In some embodiments, the collection subsystem can include one or more directional filters (not shown in FIG. 2) configured to pass light collected from a particular interval of angles of reflection (corresponding to a target numerical aperture) from sample 112. Such directional filters can be implemented via a light-absorbing plate in which suitable apertures are cut out for the passage of reflected light.

The dark-field reflection channel can collect scattered light 224, e.g., using the same objective 220 and telescope optics 218. Collected scattered light 224 can be relayed, via relay optics 216, to splitting mirror 214. Scattered light 224 incident on splitting mirror 214 outside the central aperture 213 is reflected towards polarizer 234, phase mask 240, and one or more optical elements (e.g., focusing lens, relay lens, etc., not shown in FIG. 2), which direct scattered light 224 to dark-field detectors 238. Polarizer 234 can transmit polarization that is the same as or different from the polarization produced by polarizer 208. In some embodiments, the collection subsystem can include one or more directional filters (not shown in FIG. 2) configured to pass light collected from a particular interval of angles of scattering from sample 112.

In some embodiments, objective 220 can be (or include) catadioptric optics. The catadioptric optics can include one or more semi-transparent mirrors, focusing mirrors, lenses, diffraction gratings, and/or other optical elements. The catadioptric objectives deploying focusing (e.g., spherical, ellipsoid, parabolic, etc.) mirror(s) can provide a wide field-of-view, e.g., with one or more focusing mirror(s) having a large numerical aperture (collecting scattered light 224 from a wide interval of angles). Catadioptric objectives can support different spectral distributions (e.g., wavelengths) of imaging light without introducing detrimental dispersion to the optical paths of various reflected and scattered beams.

Bright-field detectors 232 and/or dark-field detectors 238 can use photodiodes, phototransistors, complementary metal-oxide-semiconductor (CMOS) image sensors, charge-coupled devices (CCDs), hybrid CMOS-CCD image sensors, photomultiplier tubes (e.g., an array of photocathode-based pixels), or any other suitable photon detectors. Each detector, e.g., pixel, of bright-field detectors 232 and/or dark-field detectors 238 can image a separate spot on sample 112 illuminated by incident light 206. The light intensity (e.g., reflectivity) data collected by bright-field detectors 232 and/or dark-field detectors 238 can be provided to sample quality control module 124 that determines sizes/types/concentrations/locations of various defects and imperfections of sample 112. Sample quality control module 124 can be in communication with optical inspection control module 120 capable of changing settings of optical inspection system 100 (and optical inspection tool 200) based on instructions from sample quality control module 124. For example, initial inspection can be performed with a certain set resolution. When the presence of a defect is identified by sample quality control module 124, e.g., based on light reflectivity data collected by light detector 232-1 (or 232-2, etc.), sample quality control module 124 can output instructions to optical inspection control module 120 (see FIG. 1) that can change resolution of imaging by zooming the telescope optics 218 and/or objective 220 to a specific region on the sample 112 where the detected defect is located. For example, optical inspection control module 120 can change focal distance of objective 220 (or telescope optics 218, etc.), change the distance from objective 220 (or telescope optics 218, etc.) to sample 112, and/or the like. Optical inspection control module 120 can additionally change numerical apertures of various directional filters, polarizers 208, 226, and/or 234, phase masks 210, 230, and/or 240 to facilitate a change in resolution of imaging. Inspection of any given location(s) of sample 112 can be completed after a target amount of light has been collected by bright-field detectors 232 and/or dark-field detectors 238. Subsequently, the movable stage 202 can reposition sample 112 relative to incident light 206 for inspection of a different location of sample 112. Stage control module 122 can determine the distance and direction of repositioning of sample 112 so that previously uninspected spots are exposed to incident light 206.

In some embodiments, CMOS image sensors, CCD image sensors, and/or any other images sensing elements of bright-light detectors 232 and/or dark-field detectors 238 can operate in a time delay and integration (TDI) mode. For example, if light source 204 is a pulsed light source (e.g., an excimer-laser pulsed laser source), each pulse can correspond to a sensing frame. In the TDI mode, each sensing pixel may aggregate electrical signals (e.g., charge signals, voltage signals, etc.) generated during multiple sensing frames. As a result, multiple low-intensity pulses can be used to achieve high imaging sensitivity and resolution without exposing sample 112 to high-intensity beams capable of causing damage to the wafer. In those instances, where imaging is performed on a moving sample 112 (e.g., transported by movable stage 202), the signal aggregation in the TDI mode can be performed for pixels that are sequentially exposed to the light reflected or scattered from the same region of the moving sample 112.

In some embodiments, CMOS image sensors used in bright-light detectors 232 and/or dark-field detectors 238 can be high-speed and low-noise sensors. For example, CMOS image sensors can have speed at or above 1 Gigapixel per second and noise at 10e or less, e.g., in the range of 2e-5e or even less, in some embodiments.

In some embodiments, optical inspection tool 200 can include a phase contrast function. For example, a normally-incident light 206 can be split (e.g., using Wollaston prisms) into two beams with different polarizations (e.g., an s-polarized incident beam and a p-polarized incident beam). The reflected polarized beams can then pass through the polarizers to obtain a combined beam having an interference pattern that is detected by bright-field detectors 232. In some embodiments, optical inspection tool 200 can have a differential interference contrast (DIC) functionality where the normally-incident beam is split into two beams of different polarizations that follow close but different optical paths and probe two closely spaced locales of sample 112.

Although the optical inspection tool 200 in FIG. 2 is shown to include phase mask 210 in the illumination subsystem, phase mask 230 in the bright-field collection channel, and phase mask 240 in the dark-field collection channel, in other embodiments, one or more of the phase masks can be absent. In one example embodiment, phase mask 210 in the illumination subsystem can be deployed while phase masks 230 and 240 can be absent. In another example embodiment, phase mask 210 in the illumination subsystem can be absent while phase mask 230 and/or phase mask 240 can be deployed.

In some embodiments, any, some, or all phase masks 210, 230, 240 can operate by changing phase of light reflected (rather than transmitted) from the respective masks. For example, any, some, or all phase masks 210, 230, 240 can include a reflective surface partially coated with a film whose thickness is selected to impart π phase difference to light reflected from the coated portion(s) compared with light reflected from the uncoated portion(s) of the reflective surface.

In some embodiments, any, some, or all phase masks 210, 230, 240 can be combined with respective polarizers 208, 226, 234. For example, a portion of a respective polarizer can be coated with a phase-reversing coating deposited on a portion of the polarizer.

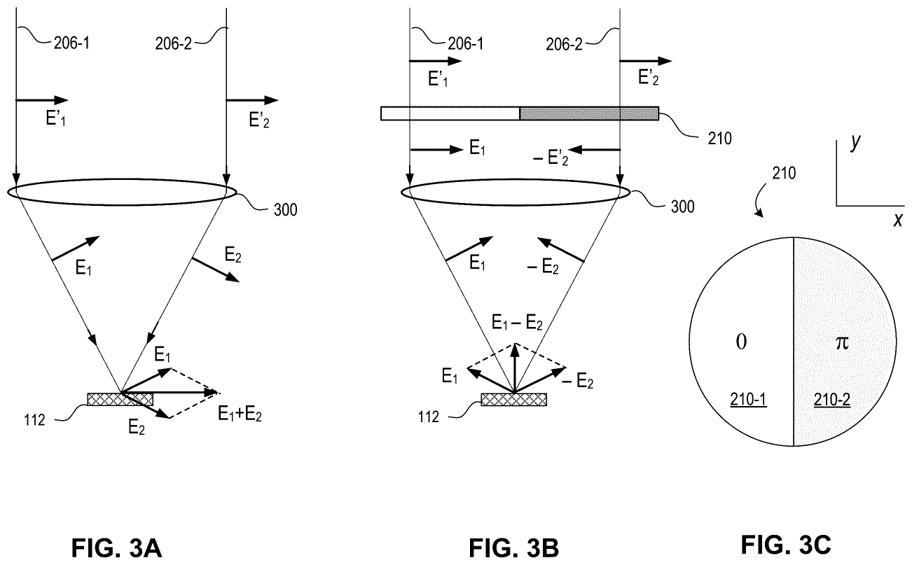

FIGS. 3A-3C illustrate deployment of an example two-segment phase mask deployed as part of an illumination subsystem of the optical inspection tool 200 of FIG. 2, in accordance with at least one embodiment. FIG. 3A illustrates a coherent linearly polarized incident light 206 focused by focusing optics 300 on a spot on the surface of sample 112. Although, for brevity and conciseness, focusing optics 300 is illustrated via a single lens in FIG. 3A and FIG. 3B, focusing optics 300 can include any number of optical elements, e.g., objective 220, telescope optics 218, relay optics 216, and/or any other suitable elements. A linearly polarized incident light is illustrated in FIG. 3A with two rays 206-1 and 206-2 with parallel (in-phase) electric fields \vec{E}′₁=\vec{E}′₂. Focusing optics 300 changes the direction of the rays and rotates the electric fields \vec{E}′₁→\vec{E}₁, \vec{E}′₂→\vec{E}₂, making the two electric fields different from (non-collinear to) each other, \vec{E}₁≠\vec{E}₂. At the surface of sample 112, the two electric fields add up to the total electric field, \vec{E}ₜₒₜ=\vec{E}₁+\vec{E}₂, that is parallel to the surface of sample 112: \vec{E}ₜₒₜ∥\hat{x}. Such fields are efficient in coupling to and exciting resonant electric dipole modes of various defects and imperfections, in which the electric dipoles are parallel to the surface of sample 112 (e.g., parallel to the x-axis).

As illustrated in FIG. 3B, when two-segment phase mask 210 is placed in the optical path of the incident light 206 and the phase of ray 206-2 is delayed (or advanced) by π relative to the phase of ray 206-1, the electric field of ray 206-2 is inverted, \vec{E}′₂→−\vec{E}′₂. As focusing optics 300 changes the direction of the rays, the directions of the electric fields in the two rays are changed accordingly \vec{E}′₁→\vec{E}₁, −\vec{E}′₂→−\vec{E}₂, as depicted in FIG. 3B. At the surface of sample 112, the two electric fields now add up to the total field, \vec{E}ₜₒₜ=\vec{E}₁−\vec{E}₂, which is perpendicular to the surface: \vec{E}ₜₒₜ∥\hat{z}. Such fields are efficient in coupling to and exciting of various defects and imperfections, in which the electric dipoles that are perpendicular to the surface of sample 112 (parallel to the z-axis). Correspondingly, to probe such z-dipole resonances, a coherent incident beam can be transmitted through a phase mask 210 illustrated in FIG. 3C that includes a first region 210-1 (indicated with phase 0) and a second region 210-2 (indicated with phase I) with rays traveled through second region 210-2 acquiring π phase (half the wavelength) difference relative to rays traveled through first region 210-1.

FIGS. 4A-4G illustrate deployment of an example two-segment phase mask of FIG. 3C to amplify out-of-plane dipole and quadrupole resonances in the detection channel of the optical inspection tool 200 of FIG. 2, in accordance with at least one embodiment. FIG. 4A illustrates two rays 224-1 and 224-2 of a scattered light emitted by a z-polarized dipole D_{z}\hat{z}. FIG. 4B illustrates a top-down view 401 of the electric field of the emitted radiation within a plane above the focusing optics (e.g., a coherent pupil plane). As illustrated in FIG. 4B, the electric field in the scattered light is radially symmetric. FIG. 4C illustrates modification of the electric field of the emitted radiation after passage of the emitted radiation through x-polarizer 234 that filters out y-components of the electric field. A top-down view 402 depicts electric field \vec{E}₁ in the left half of the pupil plane and the opposite to it electric field \vec{E}₂=−\vec{E}₁ in the right half of the pupil plane. When a focusing lens (not shown in FIG. 4A) focuses the scattered light onto a detector pixel, the electric fields largely cancel (destructive interference) resulting in a low SNR of the signal detected by the pixel. Polarizer 234 may be placed before or after phase mask 240.

FIG. 4D is a top-down view 404 illustrating additional modification of the emitted radiation achieved by passing the scattered light through the two-segment phase mask 240 that is the same as or similar to phase mask 210 of FIG. 3C. As illustrated, the direction of the electric field is reversed in the right half of the pupil plane: \vec{E}₂→−\vec{E}₂. When the focusing lens subsequently focuses the scattered light onto the detector pixel, the electric fields add (constructive interference) resulting in a significantly enhanced SNR of the signal detected by the pixel. Detecting radiation emitted by resonant dipoles (as well as resonant quadrupoles) with the z-axis of symmetry is improved by the phase masks. In some embodiments, for maximum enhancement, a two-segment π mask can be deployed both in the illumination subsystem (to enhance the z-component of the electric field at the surface of sample 112, for better coupling to the dipole/quadrupole resonances) and in the collection channel (to turn destructive interference into constructive interference, for improved the detection SNR).

FIG. 4E illustrates an example optical signal 406 collected using x-polarizer 234 that forms the picture of the electric field illustrated in FIG. 4C. FIG. 4F illustrates an example optical signal 408 collected using x-polarizer 234 and phase mask 240 that form the picture of the electric field illustrated in FIG. 4D. Maxima (bright fringes) and minima (dark fringes) of optical signal 408 are inverted compared with maxima and minima of optical signal 406. Since the main maximum in optical signal 408 has a stronger SNR than two weaker maxima in optical signal 406, the use of optical signal 408 facilitates better defect/imperfection detection and higher resolution. In particular, improved resolution enables more accurate optical inspection of patterned wafers, masks, films, and/or any other samples with small-scale features and/or structures.

FIG. 4G illustrates an example deployment of a segmented phase mask in which a central portion of the phase mask is made inaccessible to the passage of light, e.g., blocked by a directional filter 410. More specifically, the central portion of phase mask 240 (or any other phase mask, e.g., phase mask 210 and/or phase mask 243) includes a region where the imparted phase ϕ gradually changes from ϕ=0 to ϕ=π. Such a region can be less efficient in contributing to constructive interference of the light transmitted by the rest of the area of phase mask 240. Directional filter 410 can be used to block the light transmitted through the central area from reaching light detectors. This increases the SNR of the detected optical signal (by reducing the portion of the light that does not substantially improve the optical signal yet contributes to the total noise). Although FIG. 4G illustrates a segmented phase mask with a region that blocks light, in some implementations, a phase mask can have one or more regions that attenuate any target portion of light, including region(s) where attenuation function of the phase mask varies continuously with location.

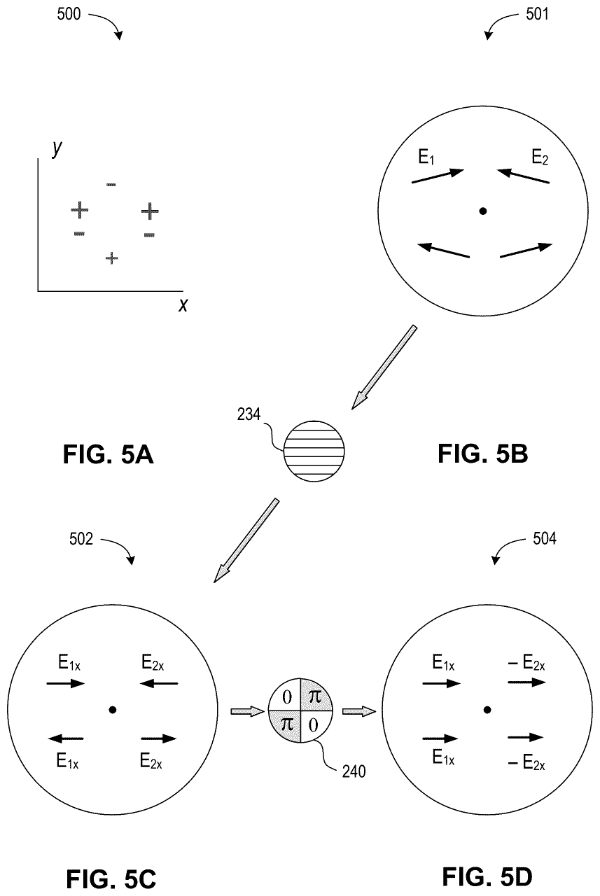

FIGS. 5A-5D illustrate deployment of an example four-segment phase mask of FIG. 3C to amplify example multipole resonances by the detection channel of the optical inspection tool 200 of FIG. 2, in accordance with at least one embodiment. FIG. 5A is a schematic top-down view 500 of a charge (or current) distribution within the plane of sample 112. FIG. 5B schematically illustrates a top-down view 501 of the electric field of the multipole-emitted radiation within the plane above the focusing optics (a coherent pupil plane). Even though application of a linear y-polarizer could lead to a same-sign component of the electric field E_{y} in both the upper and lower portions of the pupil plane, the resulting small component of the electric field E_{y} (and a low signal-to noise optical signal) can make it more efficient to apply an x-polarizer filters out the E_{y} components of the electric field. This results in a checkerboard pattern of electric field Eₓ illustrated with a top-down view 502 in FIG. 5C. In such embodiments, a four-segment phase mask 240 can be used to align the direction of electric field in all four quadrants of the pupil plane, as illustrated with a top-down view 504 in FIG. 5D. The four segments of phase mask 240 can include two segments (e.g., occupying the first quadrant and the second quadrant of the pupil plane, as shown) adding π phase to the transmitted light relative to light transmitted through the other two “0” segments (e.g., occupying the second quadrant and the fourth quadrant of the pupil plane, as shown). Polarizer 234 may be placed before or after phase mask 240.

FIGS. 6A-6D illustrate example use of birefringent materials for construction of phase masks, in accordance with at least one embodiment. Propagation of light through birefringent materials occurs with different velocities for the light polarized along an ordinary axis and the light polarized along the extraordinary axis. This property makes it possible to introduce a controlled phase shift between the two polarizations. FIGS. 6A-6D illustrate deployment of half-wave plates for improvement of optical signal. FIG. 6A illustrates an example distribution of electric field within a pupil plane of an optical inspection system (e.g., a pupil plane of the illumination subsystem or a pupil plane of the collection subsystem), in which the electric field in the left half of the pupil is anti-parallel to the electric field in the right half of the pupil. The light is then passed through a two-segment phase mask 600 having the left half-wave plate (“λ/2”), in which the fast axis (f) of a birefringent material is oriented at 45 degrees (or −45 degrees) to the direction of the electric field, and the right half-wave plate, in which the fast axis is oriented perpendicularly to the fast axis of the left half-wave plate. In one illustrative example, the thickness of the half-wave plates can be selected in such a way that the light propagating along the slow axis is delayed by half-the wavelength λ/2 relative to the fast axis. As a result, as shown in FIG. 6B, the electric field of the light that passes through the left half-wave plate is rotated by 90 degrees in one direction while the electric field of the light that passes through the right half-wave plate is rotated by 90 degrees in the opposite direction so that the electric field has the same direction everywhere within the pupil plane.

FIG. 6C illustrates another example distribution of electric field within the pupil plane, in which the electric field is tilted to 45 degrees relative to the distribution of FIG. 6A. The light is then passed through a four-segment phase mask 602 made of a uniform material with two half-plate segments having two fast axes tilted to 45 degrees (or −45 degrees) relative to the other two half-wave plate segments, resulting in the distribution of the electric field in the pupil plane as shown in FIG. 6D.

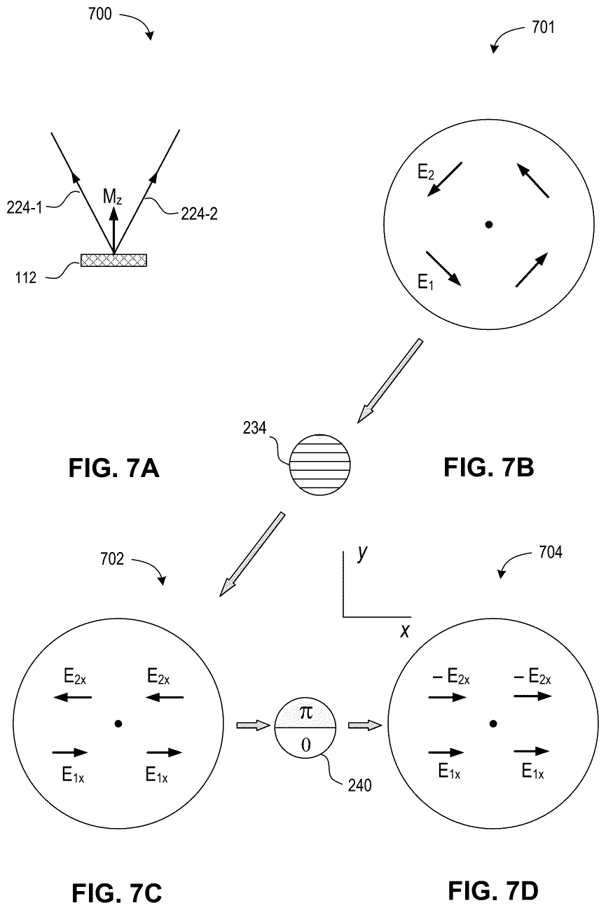

FIGS. 7A-7D illustrate another use of an example two-segment phase mask to amplify detection of magnetic dipole resonances, in accordance with at least one embodiment. FIG. 7A is a schematic depiction 700 of a radiative magnetic dipole polarized along the z-axis, M_{z}\hat{z}. FIG. 7B illustrates a top-down view 701 of the circulating electric field (within the coherent pupil plane) of the radiation emitted by the magnetic dipole. FIG. 7C illustrates a top-down view 702 of electric field after the scattered light passes through x-polarizer 234. Application of the two-segment phase mask 240 then aligns the directions of the electric field in the entire pupil plane, as illustrated with a top-down view 704 in FIG. 7D.

Phase masks illustrated in conjunction with FIGS. 3-7, e.g., two 180-degree segment masks and four 90-degree segment masks should be understood as illustrative but non-limiting examples. In some embodiments, the number of segments can be greater than four, e.g., 2n segments with n πt-phase segments and n 0-phase segments, where n can be any integer number. Such phase masks can be used to detect radiation from higher-order multipole resonances, e.g., octupole modes, etc., and/or a combination of two or more multipole modes, e.g., a dipole mode and a quadrupole mode, a dipole mode and an octupole mode, and/or the like. Although phase masks with 0- and π-phase shifts have been illustrated above, in some embodiments the relative shifts in the two (or more) segments of phase masks can be different from π, e.g., can be more than π or less than π. In some embodiments, phase masks can also serve as amplitude masks, e.g., with different segments of the phase masks having different transmission coefficients. For example, 0-phase shift regions can have a first transmission coefficient T₁ and π-phase shift regions can have a second transmission coefficient T₂ different (e.g., smaller or larger than the first transmission coefficient T₁. Although phase masks illustrated above have circular shapes, in other embodiments phase masks can have non-circular shapes, e.g., oval shapes, square shapes, rectangular shapes, and so on.

Even though the above examples have been illustrated in conjunction with the use of phase masks in the illumination subsystem (FIGS. 3A-3C) and the dark-field scattering channel (FIGS. 4-7), substantially the same or similar techniques can be used to deploy phase masks in the bright-field reflection channel.

The disclosed techniques can be used with any optical inspection configuration, e.g., with spot illumination (such as scanning spot illumination), line scan illumination, area (flood beam) illumination, and/or the like. In spot illumination, coherent light can be focused on a spot (a small area) of sample 112. The light collected from the spot can be associated with a single imaging pixel (or a small number of such pixels). Once a target amount of scattered and/or reflected light has been collected from a given spot of sample 112, a value characterizing the amount of collected light (and its polarization, etc.) can be stored in association with the location of the spot and the focused beam can be moved to a different (e.g., adjacent) spot of sample 112. In scanning line illumination, the incident light can be focused (e.g., using a cylindrical lens) on a line-shaped area of sample 112. In area illumination, an incoherent (or partially coherent) light can be used to illuminate a larger area of sample 112, e.g., a 2×2 mm area (or an area of some other size). The collection optics can then collect the scattered/light coherently to form an image onto a sensor, e.g., a camera sensor. In all instances of spot illumination, line scan illumination, and an area illumination, optical inspection can include simultaneous or sequential bright-field (e.g., using bright-field detectors 232) and/or dark-field (e.g., using dark-field detectors 238) inspection of sample 112.

In some embodiments, phase masks can be made using a static combination of mechanical and optical elements. For example, 0-phase region(s) of phase masks can be made from one material and π-phase region(s) can be made from a different material. In some embodiments, 0-phase region(s) and π-phase region(s) can be made from the same material while π-phase region(s) (or, alternatively, 0-phase region(s)) can be additionally coated with a film of a suitably chosen material and a thickness selected in such a way that the transmitted light acquires the half-wavelength shift. In some embodiments, phase masks can be implemented using acousto-optic and/or electro-optic elements.

For example, in the instances where an electro-optic modulator (EOM) is being used, e.g., a piezoelectric modulator (such as lithium niobate-based modulator), same voltages (or electric fields) can be applied to two (or more) portions of EOM having different thicknesses, such that a combination of the applied voltage and different thicknesses causes π phase difference incurred by the light passing through the two portions. Alternatively, different voltages (or electric fields) can be applied to the two (or more) portions of EOM having the same thickness (to cause the same π phase difference). In some embodiments, a combination of these techniques can be used, with two (or more) portions having different thicknesses and receiving different voltages. Controlling voltages can also be used to cause the two lights having a phase difference other than π, e.g., π/2, 3π/2, or a phase difference between π/2 and 3π/2, or within other limits.

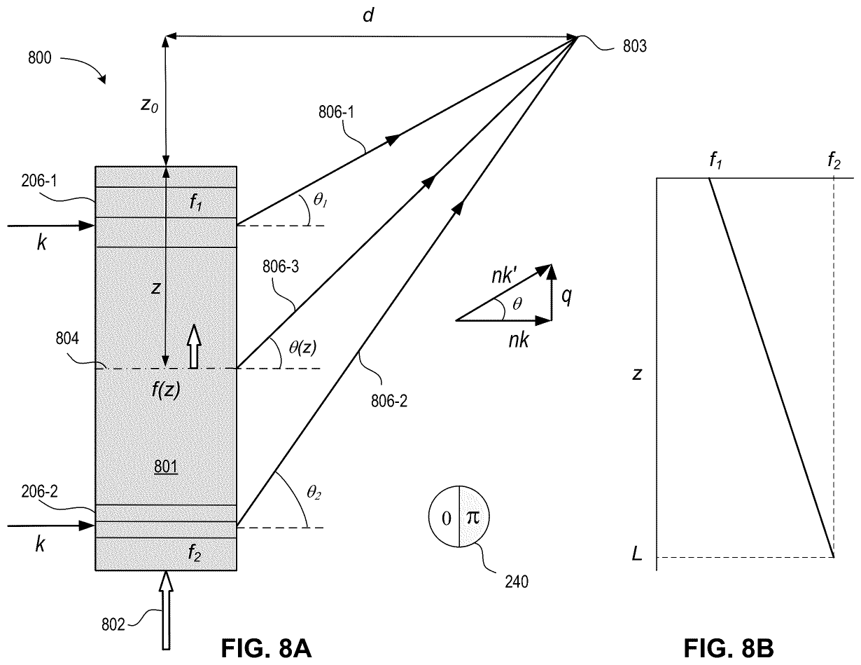

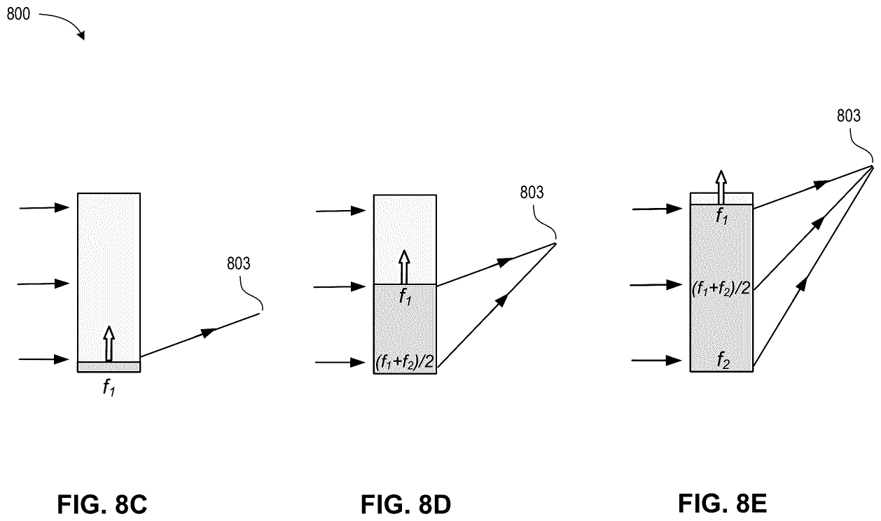

FIGS. 8A-8B illustrate an example embodiment of a phase mask that deploys an acousto-optic modulator (AOM), in accordance with some aspects of the present disclosure. An AOM 800 can include a transparent portion 801 that receives an incident electromagnetic wave, where two regions 206-1 and 206-2 are depicted schematically in FIG. 8A. AOM 800 can be subjected to a frequency-modulated sound wave 802 generated by a transducer (not shown in FIG. 8A), e.g., a piezoelectric transducer capable of inducing acoustic waves of controlled amplitude, phase, and frequency f inside AOM 800. In some embodiments, the induced sound wave 802 can be a propagating wave (e.g., with the other end of AOM 800 coupled to a second transducer that induces matching oscillations of the AOM material to prevent formation of a reflected sound wave). A light wave propagating with wave vector \vec{k} within the transparent portion 801 can experience Bragg reflection from modulations of the elastic deformation of the AOM material. Bragg reflection occurs with wave vector conservation, \vec{k}′=\vec{k}+\vec{q}/n, causing the diffracted wave vector \vec{k}′ to change from the incident wave vector \vec{k} by a wave vector \vec{q} of the sound wave, q (or an integer number of the wave vectors \vec{q}); n denoting the refractive index of the AOM material. The scattering of the light wave occurs to an angle θ determined by the Bragg condition,

$$θ \approx \frac{q}{nk} = \frac{λ f}{n s} ,$$

where λ is the wavelength of the light in vacuum (k=2π/λ), f is the sound frequency, and s is the speed of sound wave 802 in the AOM material.

The sound wave propagating within AOM 800 can be amplitude A(t) and/or phase-modulated ϕ(t). The modulation of the sound wave can cause AOM 800 to operate as a generator of a travelling lens, with output beams 806-1 and 806-2 focusing on a particular spot 803 of the sample (any intervening optical elements not shown for conciseness), the spot 803 moving across the surface of the sample in response to the propagation of the sound wave 802 across AOM 800. In one example non-limiting embodiment, the frequency of the sound wave 802 can have a linear chirp, e.g., from the low value f₁ to the high value f₂ (followed by a reset back to frequency f₁), as illustrated in FIG. 8B,

$$f ( t ) = {f}_{1} + ( {f}_{2} - {f}_{1} ) \frac{t}{{T}_{c}}$$

where T_{c} is a chirp period. If the chirp period matches the time of propagation of the sound wave across a length L of AOM 800, L≈s·T_{c}, each chirp period gives rise to a cycle of motion of the illuminated spot 803. For example, for an L=2 mm AOM 800 and the speed of sound of s=5×10³ m/s, the chirp period can be T_{c}=2 mm÷(5×10³ m/s)=4×10⁻⁷ s. FIGS. 8C-8E illustrates schematically such motion, with FIG. 8C indicating diffraction of light from the sound wave having initial frequency, FIG. 8D depicting diffraction of light at mid-period of chirping, and FIG. 8E showing diffraction of light near the end of the chirp period. As further illustrated in FIG. 8A for the same picture of the end of chirp period as in FIG. 8E, the diffraction angle (for a linear chirp) is a linear function of the vertical coordinate z (0≤z≤L),

$$θ ( z ) = \frac{λ}{n s} ( {f}_{1} + ( {f}_{2} - {f}_{1} ) \frac{z}{L} ) ,$$

such that all output beams 806-1, 806-2, 806-3, etc., intersect at the same spot 803 located at horizontal distance d and vertical distance z₀ from the top of AOM 800:

$$d ( z ) = \frac{nsL}{λ ( {f}_{2} - {f}_{1} )} , {z}_{0} = \frac{{f}_{1} L}{{f}_{2} - {f}_{1}} .$$

The phase and amplitude modulation of the sound wave can be used to configure the output beams to have a π-phase difference (or some other desired phase difference). For example, during the first half of the chirp duration, t∈(0, T_{c}/2), the amplitude of the sound wave can have a first value and phase that is equal to ϕ(t)=2π(f₁t+(f₂−f₁)t²/2T_{c}). During the second half of the chirp duration, t∈(T_{c}/2,T_{c}), the amplitude of the sound wave can have a second sign that is opposite to the first sign, adding phase π to the phase, ϕ(t)→(t)+π, flipping the sign of the transducer′ Signal(t)=Amplitude(t)·sinϕ(t). This also flips the phase of the beams propagating within the interval enclosed by beams 806-2 and 806-3 compared with the beams propagating within the interval enclosed by beams 806-1 and 806-3.

Various other implementations of phase masks are within the scope of the instant disclosure. In some embodiments, a phase mask can be implemented with a spatial light modulator (SLM), e.g., a liquid crystal based SLM, that change refractive index of the SLM causing the light to experience a (e.g., voltage-controlled) phase change. Different segments of a phase mask can experience different voltages causing a desired phase difference to be imparted to different portions of light in the pupil plane. In some embodiments, phase masks can be implemented using deformable mirrors, e.g., micro-electro-mechanical (MEM) deformable mirrors or piezoelectric deformable mirrors. Deformable mirrors change the optical wavefront in reflection by a deformed surface shape. For example, MEM deformable mirrors use multiple electrostatic actuators to change a shape of the surface of a membrane coated with a reflective film. When placed in a reflective pupil plane, the surface deformation results in phase differences between rays reflected at different angles. This phase difference can be engineered to have the form of phase masks, e.g. as illustrated in conjunction with FIGS. 4A-4G and FIGS. 5A-5D.

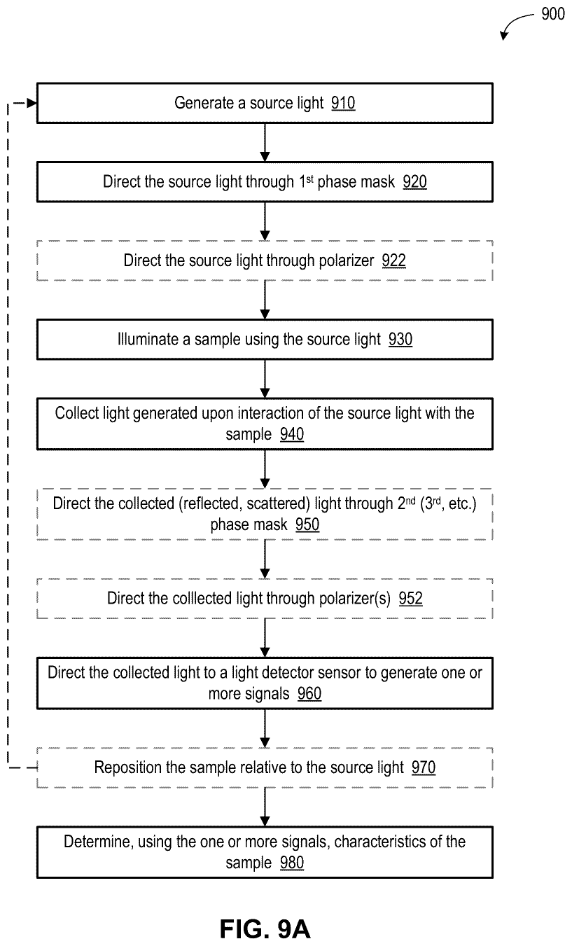

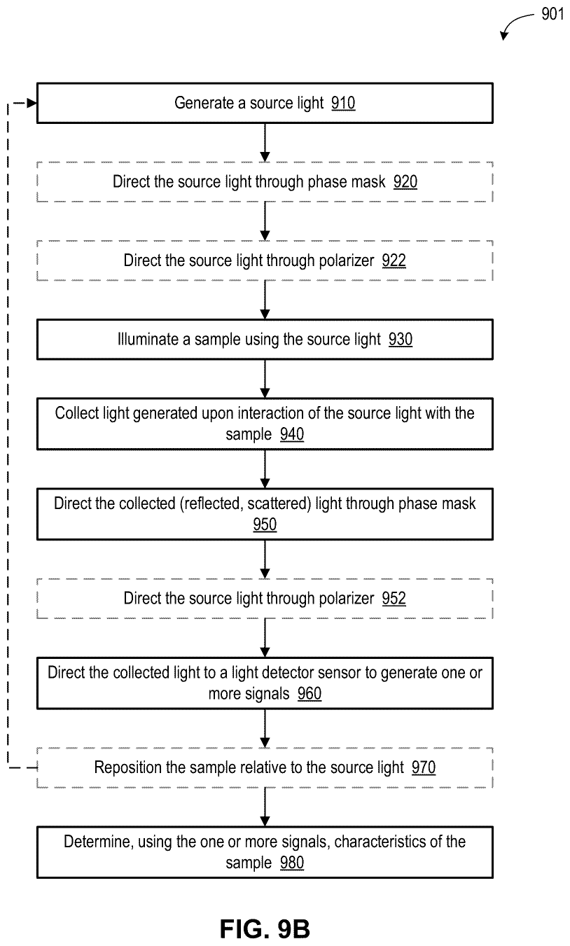

FIGS. 9A-9B are flow diagrams of example methods 900 and 901 of deploying phase masks for improving optical inspection signals, in accordance with at least one embodiment. Method 900 can deploy phase masks for configuring a source light used in optical inspections. Method 901 can deploy phase masks for configuring a light collected (e.g., reflected, scattered) during optical inspections. Operations of blocks indicated with dashed lines can be optional during execution of the corresponding methods. For example, use of a phase mask to configure collected light (blocks 950) can be optional during execution of method 900, while use of a phase mask to configure source light (blocks 920) can be optional during execution of method 901. In some embodiments, method 900 can be combined with method 901, e.g., with both the source light and scattered light configured using respective phase masks. Method 900 and/or method 901 can be performed using systems and components illustrated in FIGS. 1-8 or some combination thereof. In some embodiments, method 900 and/or method 901 can be performed in conjunction with operations of a semiconductor manufacturing system. Some or all blocks of method 900 and/or method 901 can be performed responsive to instructions from computing device 118 and/or electronics module 130 of FIG. 1. Computing device 118 and/or electronics module 130 can include one or more processing devices, such as central processing units (CPUs), application-specific integrated circuits (ASICs), field programmable gate arrays (FPGAs), digital signal processors (DSPs), network processors, or the like. The processing device(s) can be communicatively coupled to one or more memory devices, such as read-only memory (ROM), flash memory, static memory, dynamic random-access memory (DRAM), and the like. In some embodiments, computing device 118 and/or electronics module 130 can be connected to a larger network of computing devices. In some embodiments, method 900 and/or method 901 can be performed while the sample is still positioned inside a processing chamber. In some embodiments, method 900 and/or method 901 can be implemented once the sample has been removed from the processing chamber. The inspection process can occur at low temperatures, or at temperatures that are less or significantly less than the room temperature. Alternatively, the inspection process can occur at room temperature, above room temperature, or significantly above room temperature. In some embodiments, during the inspection process, the sample can experience pressure that is less than the atmospheric pressure, including low vacuum or high vacuum conditions.

In some embodiments, an inspection system performing method 900 and/or method 901 can be PME optical inspection tool 114, which can include an illumination subsystem, a collection subsystem, and/or detection subsystem. PME optical inspection tool performing method 900 and/or method 901 can further include a polarization filtering stage, a directional filtering stage, and or the like.

The directional filtering stage of the PME optical inspection tool performing method 900 and/or 901 can include one or more directional filters configured to pass light collected from a particular interval of angles of reflection (or scattering) from the sample. Directional filters can be implemented via a light absorbing plate in which suitable apertures are cut out for the passage of light. Some of the apertures can admit the normally reflected light whereas other apertures can admit scattered light. In some embodiments, directional filters can be positioned at the Fourier plane of the objective of the collection subsystem.

In some embodiments, the detection subsystem can include a relay optics having one or more optical elements (e.g., lenses, mirrors, waveguides, arrays of waveguides, etc.) used to deliver (e.g., focus) the reflected and scattered light on one or more light detectors. The light detectors can use complementary metal-oxide-semiconductor (CMOS) image sensors, charge-coupled devices (CCDs), hybrid CMOS-CCD image sensors, photomultiplier tubes (e.g., an array of photocathode-based pixels), photodiodes, phototransistors, or any other suitable photon detectors. Each light detector of the detection subsystem can image a separate spot (pixel) of the sample illuminated by the illumination subsystem.

The light intensity (e.g., reflectivity) data collected by the light detectors can be provided to sample quality control module 124 that determines sizes, types, concentrations, and/or locations of various defects and imperfections of sample 112. Sample quality control module 124 can be in communication with optical inspection control module 120, which can be capable of changing settings of the illumination subsystem, the collection subsystem, the detection subsystem, the polarization filtering stage, the directional filtering stage, and/or other systems and stages. For example, an initial inspection of the sample can be performed with a certain set resolution. When presence of a defect is identified by sample quality control module 124, e.g., based on light reflectivity data collected by the detection subsystem, sample quality control module 124 can output an instruction to optical inspection control module 120 that can change resolution of imaging by zooming the illumination subsystem and/or the collection subsystem to a specific region of the sample where the defect is located. More specifically, optical inspection control module 120 can change a focal distance of the objective of the collection subsystem, the distance from the objective to the sample, and so on. Optical inspection control module 120 can additionally change numerical apertures of directional filters of the directional filtering stage to facilitate a change in imaging resolution. Stage control module 122 can determine the distance and direction of repositioning of the sample so that previously uninspected spots are exposed to the light pulses. Stage control module 122 can further ensure coordination between the motion of the movable stage 110 and the collection of the inspection data.

In some embodiments, the PME optical inspection tool can be deployed with a default phase mask (e.g., a phase mask with a given number of 0-phase and π-phase segments, e.g., two-segment phase mask 210 of FIG. 3C) having a fixed orientation, e.g., relative to the direction of scanning of the sample. In such embodiments, once an existence of a defect at a particular location of the sample is detected using the default phase mask, electronics module 130 can cause the PME optical inspection tool to collect additional optical signals using one or more of: different orientations of the default phase mask (e.g., by rotating the default mask by 90 degrees and/or other angle), other phase masks (e.g., four-segment phase mask) used in place of the default phase mask, different polarizers (or orientations of polarizers), and/or the like, or some combination thereof. In some embodiments, the default phase mask can be of such a type and orientation as to facilitate detection of defects/imperfections of the most likely encountered kind (e.g., defects with dipole resonances polarized perpendicularly to the surface of the sample). In some embodiments, the PME optical inspection tool can be programmed to collect optical signals using multiple phase masks (and/or combinations of phase masks/polarizers) for each location of the sample.

At block 910, method 900 and/or method 901 can include generating a source light (e.g., incident light 206 in FIG. 2). In some embodiments, the source light can be generated using a gas laser, a semiconductor laser, a laser diode, an excimer laser (e.g., a laser with an excimer gain medium), and/or other light source (or multiple light sources). The source light can include a continuous light, pulsed light, or some combination thereof.

At block 920, method 900 and/or method 901 can include directing the source light to a first phase mask (e.g., phase mask 210). In some embodiments, the first phase mask (and other phase masks, if deployed) can include a first region (e.g., the “0” segment of phase mask 210 in FIG. 3C) to interact with a first portion of the source light, and a second region (e.g., the “π” segment of phase mask 210) to interact with a second portion of the source light. The first (second, etc.) phase mask can cause the second portion to phase-shift relative to the first portion by half a wavelength λ (or approximately half the wavelength) of the source light (π-phase shift). In some implementations, the second region of the phase mask is to phase-shift the second portion of the light relative to the first portion by a phase shift that is between 0.45λ and 0.55λ. In some implementations, the second region of the phase mask is to phase-shift the second portion of the light relative to the first portion by a phase shift that is between λ/4 and 3λ/4. In some embodiments, the first region can include air or a first material (e.g., glass) and the second region can include a second material different from the first material. In some embodiments, the second region can include the first material of a different thickness compared with the thickness of the first region. In some embodiments, the second material can be a coating placed on the first (or a different, third, material). In some embodiments, the first region and/or the second region can include one or more birefringent materials, e.g., one or more half-wave plates and/or quarter-wave plates. In some embodiments, the phase mask can be combined with a polarizer into a single device. For example, the first material can be a polarizer material and the second material can be a phase-reversing coating deposited on a portion of the polarizer material.

In some embodiments, the first region and, similarly, the second region, can include a plurality of spatially separated portions (e.g., a first region of phase mask 240 illustrated in FIGS. 6A-6D includes two “0” segments located diagonally across and further includes two “π” segments similarly located opposite to each other).

In some embodiments, the first (second, etc.) phase mask can be a transmission mask (that modifies phase of the light transmitted through the mask). In some embodiments, the first (second, etc.) phase mask can be a reflection mask (that modifies phase of the light reflected from the mask).

In some embodiments, the first phase mask can include an acousto-optic modulator (e.g., AOM 800 in FIG. 8A) supporting a sound wave of a temporally modulated frequency (as illustrated in FIG. 8B). AOM can be configured to diffract, in a first direction (e.g., first diffracted ray 806-1), the first portion of the source light (e.g., first incident ray 206-1), and diffract, in a second direction (e.g., second diffracted ray 806-2), the second portion of the source light (e.g., second incident ray 206-1).

In some embodiments, the first (second, third, etc.) phase mask can be mechanically engaged by an actuator configured to reposition the first (second, third, etc.) phase mask, e.g., rotate or flip the phase mask, or replace the phase mask with a different phase mask (e.g., replace phase mask 240 of FIGS. 6A-6D with phase mask 210 of FIG. 3C or vice versa), remove the first (second, third, etc.) phase mask from an optical path of the respective (e.g., incident, reflected, or scattered) beam, and/or the like.

In some embodiments, the first (second, etc.) phase mask can be positioned at a pupil plane of the illumination subsystem or a pupil plane of the collection (e.g., bright-field reflection and/or dark-field scattering) subsystem.

At block 922, method 900 and/or method 901 can include directing the source light to a first polarizer. In some embodiments, the first polarizer (and/or other polarizers, if deployed) can be positioned to polarize the source light prior to the source light's interaction with the phase mask. In some embodiments, the first (second, etc.) polarizer can be positioned to polarize the source light after interaction of the source light with the phase mask.

At block 930, method 900 and/or method 901 can include with illuminating the sample using the source light. In some embodiments, the sample can be illuminated using s-polarized source light, p-polarized source light, a right-handed circularly (or elliptically) polarized source light, left-handed circularly (or elliptically) polarized source, partially-polarized source light, or any combination (e.g., superposition) thereof.

At block 940, method 900 and/or method 901 can include with collecting (e.g., a part of) light generated upon interaction of the source light with the sample. The generated portion of light can be collected by the collection subsystem. The generated light should be understood as including specularly reflected light and/or diffusely reflected (scattered) light. The collection subsystem can include an objective (having one or more lenses and/or one or more curved mirrors), one or more polarizing elements, one or more directional filters, beam splitters, elements of relay optics, and/or the like. Some of the components of the collection subsystem(s) can be shared with the illumination subsystem(s), e.g., objective, beam splitters, polarizers, and so on. The collection subsystem can be configured into one of a plurality of configurations. In some embodiments, in each of the plurality of configurations, the collection subsystem can be characterized by a different size of a region of the sample from which the portion of light is collected. In some embodiments, changing the collected light can be performed by moving a side aperture of a directional filter to a different position relative to the optical axis of the collection subsystem (or replacing a directional filter with another filter having a differently-positioned side aperture).

At block 950, method 900 and/or method 901 can include with directing the collected light to a second (third, etc.) phase mask. For example, the reflected (bright-field) light can be directed to the phase mask 230 (in FIG. 2) and the scattered (dark-field) light can be directed to phase mask 240. At block 952, method 900 and/or method 901 can include directing the collected light to a second polarizer. Operations of blocks 950 and 952 performed in conjunction with collection of reflected/scattered light can be similar to operations of blocks 920 and 922 performed in conjunction with illumination of the sample.

At block 960, method 900 and/or method 901 can include directing the collected light to a light detection sensor to generate one or more signals. The one or more signals (e.g., electrical signals) can be representative of a state (e.g., quality) of the sample. In some embodiments, the light detection sensor can include a CMOS image sensor. In some embodiments, an array of light detectors can include a CCD camera. In some embodiments, an array of light detectors can include an array of photomultiplier tubes.

At block 970, method 900 and/or method 901 can include repositioning, using a movable stage, the sample relative to the source light. In some embodiments, repositioning the sample can include imparting to the sample a combination of a translational motion and a rotational motion. As indicated with the dashed arrow in FIG. 9, after repositioning of the sample, the operations of blocks 910-960 can be repeated for the new regions of the sample being exposed to the source light.

At block 980, method 900 and/or method 901 can include determining, using the one or more generated signals, one or more characteristics of the sample. For example, a processing device can process the generated signals and determine locations, types, amounts, etc., of various defects and imperfections that are present on the surface of the sample or in the bulk of the sample. The processing device can then determine whether the detected defects and/or imperfections place the sample outside a specification of the technological process being performed or if the sample comports to the specification.

In some embodiments, method 900 and/or method 901 can include configuring, responsive to the detected defects and/or imperfections, one or more processing operations of the manufacturing system. For example, configuring the processing operation(s) can include performing some remedial processing of the sample, e.g., performing additional polishing of the sample, etching and/or deposition. In some instances, adjustments can be applied to subsequent samples processed by the manufacturing system. For example, such adjustments can include modifying chemical composition, pressure, temperature, etc., of an environment of some portion of the manufacturing system, such as a processing chamber, a transfer chamber, a loading chamber, and/or the like.

It should be understood that the above description is intended to be illustrative, and not restrictive. Many other embodiment examples will be apparent to those of skill in the art upon reading and understanding the above description. Although the present disclosure describes specific examples, the systems and methods of the present disclosure are not limited to the examples described herein and may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but may refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

What is claimed is:

1. A sample inspection system comprising:
an illumination subsystem to generate a light incident on a sample;
a collection subsystem comprising one or more optical elements to collect a light generated upon interaction of the incident light with the sample; and
a light detection subsystem configured to detect the collected light and generate one or more signals representative of one or more characteristics of the sample; and
wherein the sample inspection system comprises a first phase mask positioned to interact with at least one of the incident light or the collected light, and wherein first phase mask comprises at least:
a first region to engage a first portion of a light interacting with the first phase mask, and
a second region to (i) engage a second portion of the light interacting with the first phase mask and (ii) phase-shift the second portion relative to the first portion.

2. The sample inspection system of claim 1, wherein the second region of the first phase mask is to phase-shift the second portion of the light relative to the first portion by a phase shift that is between λ/4 and 3λ/4, wherein λ is a wavelength of the light incident on the first phase mask.

3. The sample inspection system of claim 1, wherein the second region of the first phase mask is to phase-shift the second portion of the light relative to the first portion by half a wavelength of the light incident on the first phase mask.

4. The sample inspection system of claim 1, wherein the first phase mask is positioned within an optical path of the incident light, and wherein the sample inspection system further comprises a second phase mask positioned within an optical path of the collected light.

5. The sample inspection system of claim 4, wherein the collected light comprises a light reflected from the sample and a light scattered from the sample, wherein the first phase mask is positioned within an optical path of reflected light and the second phase mask is positioned within an optical path of the scattered light.

6. The sample inspection system of claim 1, wherein the first region comprises air or a first material of a first thickness and the second region comprises at least one of:
a second material, or
the first material of a second thickness.

7. The sample inspection system of claim 1, wherein the first region comprises a first material and the second region comprises the first material and a second material, wherein the first material comprises a polarizing material.

8. The sample inspection system of claim 1, wherein at least one of the first region or the second region comprises one or more birefringent materials.

9. The sample inspection system of claim 1, wherein the first phase mask comprises at least one of:
an acousto-optic modulator supporting a sound wave that causes the first portion of light and the second portion of light to form the incident light that dynamically scans the sample,
one or more segments made of a liquid crystal material, or
a deformable mirror.

10. The sample inspection system of claim 1, wherein the first phase mask comprises an electro-optic modulator; and wherein at least one of (i) a first thickness of the first region of the first phase mask or (ii) a first voltage applied to the first region of the first phase mask is different from a corresponding one of (i) a second thickness of the second region of the first phase mask or (ii) a second voltage applied to the second region of the first phase mask.

11. The sample inspection system of claim 1, further comprising a polarizing optical element to:
polarize, prior to interaction with the first phase mask, the light interacting with the first phase mask, or
polarize, after interaction with the first phase mask, at least one of the first portion of the light or the second portion of the light.

12. The sample inspection system of claim 11, wherein the polarizing optical element comprises at least one of:
a linear polarizer,
a segmented polarizer,
a half-wave plate,
a quarter-wave plate, or
an S-waveplate converter.

13. The sample inspection system of claim 1, wherein the first phase mask is positioned at a pupil plane of the illumination subsystem or a pupil plane of the collection subsystem.

14. The sample inspection system of claim 1, wherein the first phase mask attenuates at least a fraction of (i) the first portion of the light or (ii) the second portion of the light.

15. The sample inspection system of claim 1, further comprising:
an actuator configured to perform at least one of:
repositioning of the first phase mask,
replacement of the first phase mask with a second phase mask, or
removal of the first phase mask from an optical path of the at least one of the incident light or the collected light.

16. The sample inspection system of claim 1, wherein each of the first region and the second region of the first phase mask comprises a plurality of spatially separated portions.

17. The sample inspection system of claim 1, further comprising:
a processing device configured to determine, using the one or more signals, the one or more characteristics of the sample.

18. The sample inspection system of claim 1, wherein the second region of the first phase mask is to rotate polarization of the second portion of the light relative to the first portion of the light.

19. A method to perform an optical inspection of a sample, the method comprising:
generating a source light;
directing the source light to a first phase mask, wherein the first phase mask comprises:
a first region to interact with a first portion of the source light, and
a second region to (i) interact with a second portion of the source light and (ii) phase-shift the second portion of the source light relative to the first portion of the source light;
illuminating the sample using the source light;
collecting a light generated upon interaction of the source light with the sample;
directing the collected light to a light detection sensor to generate one or more of signals; and
determining, using the one or more signals, one or more characteristics of the sample.

20. The method of claim 19, further comprising:
directing the collected light to a second phase mask.

21. A method to perform an optical inspection of a sample, the method comprising:
generating a source light;
illuminating the sample using the source light;
collecting a light generated upon interaction of the source light with the sample;
directing at least a part of the collected light to a first phase mask, wherein the first phase mask comprises:
a first region to interact with a first portion of the collected light, and
a second region to (i) interact with a second portion of the collected light and (ii) phase-shift the second portion of the collected light relative to the first portion of the collected light;
directing the collected light to a light detection sensor to generate one or more signals; and
determining, using the one or more signals, one or more characteristics of the sample.

22. The method of claim 21, wherein the collected light comprises a first part reflected from the sample and a second part scattered from the sample, wherein the first phase mask is positioned within an optical path of the first part of the collected light, the method further comprising:
directing the second part of the collected light to a second phase mask.
